(19) United States
(12) Patent Application Publication
(10) Pub. No.: US 2025/0278456 A1
(43) Pub. Date: Sep. 4, 2025

(54) DATA ANALYSIS METHODOLOGY FOR PARTICLE MANIPULATION DEVICES

(71) Applicant: Owl biomedical, inc., Goleta, CA (US)

(72) Inventor: Mark NAIVAR, Goleta, CA (US)

(73) Assignee: Owl biomedical, inc., Goleta, CA (US)

(21) Appl. No.: 18/592,887

(22) Filed: Mar. 1, 2024

(51) Int. Cl. G06F 18/2135; G01N 15/14; G06F 18/2132

(52) U.S. Cl. CPC G06F 18/2135; G01N 15/1459; G06F 18/2132; G01N 2015/1402

(57) ABSTRACT

A data analysis routine may include the following steps: preprocessing; high dimensional reduction; analysis; and visualization. Each of these steps may include a number of sub steps, and the result may be a well separated and enriched population of target particles upon which further analysis may be made.

### CROSS REFERENCE TO RELATED APPLICATIONS

Not applicable.

### STATEMENT REGARDING FEDERALLY SPONSORED RESEARCH

Not applicable.

### STATEMENT REGARDING MICROFICHE APPENDIX

Not applicable.

### BACKGROUND

This invention involves a workflow that uses high-dimensional data reduction techniques to analyze cytometric or biological imaging data to efficiently isolate one or more populations from a heterogeneous mixture of cells.

Flow cytometry instruments commonly share a goal to either sort a specific cell population from a sample or analyze a broad sample containing various cell populations. By utilizing the proposed approach, sorting of cells can be done on a flow cytometry instrument with only one plot, unlike the traditional gating strategy that requires complex nested gating.

High-dimensional data reduction techniques are commonly used across various fields, all of which can be utilized for various purposes depending on the application. In the field of flow cytometry, high-dimensional data reduction techniques can be used to visualize the fluorescent data captured by the given instrument, while preserving as much of the original information as possible. There are various high-dimensional data reduction techniques, each of which has a particular fundamental goal from which they operate. As with any synonymous process in data science or machine learning, each technique will have its own distinct set of attributes which must be carefully understood to provide the best results for each specific application. Some commonly used high-dimensional data reduction techniques include Principal Component Analysis (PCA), Linear Discriminant Analysis (LDA), Uniform Manifold Approximation and Projection (UMAP), t-distributed Stochastic Neighbor Embedding (t-SNE), etc.

### SUMMARY

The algorithms disclosed here involve data reduction and enrichment processes that can be utilized by flow cytometry instruments.

Data enrichment involves improving, enhancing, and refining raw data. By enriching data, valuable analytic information can be extracted, ultimately improving a specific aspect. This process of enriching a specific set of data is highly dependent on what the goal and application is. The field of flow cytometry is limited by the biological properties of the cells being analyzed, the properties of the specific instrument being used, and the underlying goal of the analysis. By introducing a form of enrichment, improvements to the resulting analysis can be made.

Accordingly, the novel workflow may include the following steps: preprocessing; high dimensional reduction; exhaustive analysis; and visualization. Each of these steps may include a number of sub steps, as described herein. The result is an enriched population of target particles upon which further analysis may be made.

The first fundamental step of this workflow involves pre-processing the data that has been collected by the flow cytometry instrument. Subsetting of the data is critical to ensure that only the most valuable information is being used for the subsequent steps. Transforming the resulting data is essential to enhance the performance of the resulting workflow. Finally, enrichment of the specific cell population of interest allows for enhancement of the relevant features prior to the high-dimensional data reduction techniques.

The specific high-dimensional data reduction techniques being utilized for this workflow include PCA and LDA. For each subsequent pre-processing step (specifically, the transformation and the enrichment) PCA and LDA are independently deployed. For one principal component analysis, the relevant principal components (principal component 1, principal component 2, and principal component 3) and the linear discriminants from linear discriminant analysis (linear discriminant 1) are extracted without prior enrichment. The same is done for the data following enrichment. Following these four high-dimensional data reduction techniques, eight distinct projections are extracted (principal component 1, principal component 2, principal component 3, linear discriminant 1, enriched principal component 1, enriched principal component 2, enriched principal component 3, and enriched linear discriminant 1).

An exhaustive analysis step is used to verify which combination of projections yields the best projection following the high-dimensional data reduction step. Generally, three steps are involved for this piece of the workflow (implementation of a classification model, analysis with a classification metric, and an exhaustive search for the best scoring metric). Although the exact classification metric and model being implemented will again vary depending on the application of choice, one proposed combination involves using the radial basis function kernel with a support vector machine. This classification model is used to determine the viability of the proposed combination of projections, while essentially mimicking a gating strategy that can be used on a flow cytometry instrument. A support vector machine will produce a hyperplane that best separates the data points of interest, while the radial basis function kernel allows for non-linear decision boundaries (again, this allows for mimicking of the gating strategies seen in the field).

The final step of the workflow is visualization and application of the best combination found from the prior exhaustive analysis step. Due to the linear nature of both principal component analysis and linear discriminant analysis, the transformation matrix can be extracted from each respective high-dimensional data reduction technique. By extracting the eigenvectors corresponding to the specific principal components and/or linear discriminant, one can implement and manually transform the data being collected by the flow cytometry instrument in real time.

Accordingly, the analysis process may include obtaining the data; performing dimensional data reduction on the data; analyzing the dimensionally reduced data; and visualizing the analyzed and dimensionally reduced data.

### BRIEF DESCRIPTION OF THE DRAWINGS

Various exemplary details are described with reference to the following figures, wherein:

FIG. 1a is a simplified high level illustration of a data analysis process flow. FIG. 1b is an illustration showing further detail of the pre-processing modules; FIG. 1c is an illustration showing further detail of the high dimensional data reduction module; FIG. 1d is an illustration showing further detail of the exhaustive analysis modules; FIG. 1e is an illustration showing further detail of the visualization and application modules;

FIG. 2 illustrates the traditional view of how a user would sort or separate a Treg population;

FIG. 3 is an illustration of PCA transformation of the data;

FIG. 4 is an illustration of transformed dataset following SMOTE enrichment and PCA;

FIG. 5 is an illustration of transformed data following a PCA/LDA hybrid transformation.;

FIG. 6 is an illustration of transformed data following a SMOTE enriched PCA/LDA hybrid transformation; and

FIG. 7 is a table showing the results of the data analysis routine; and

FIG. 8 illustrates a transformation matrix.

### DETAILED DESCRIPTION

Terms used herein are standard in the art of data analysis, and are intended to be understood as such. However, for completeness and convenience, some of the terms are defined below.

High dimensional data is data that are measured along a plurality of axes, in other words, data in which the number of features (variables observed), p, are close to or larger than the number of observations (or data points), n. The opposite is low-dimensional data in which the number of observations, n, far outnumbers the number of features,

Pre-processing may include any of the following: filtering, gating, truncating, smoothing, interpolating, extrapolating and/or weighing of data.

SMOTE is an acronym of synthetic minority oversampling technique. SMOTE is one of the most commonly used oversampling methods to solve the imbalance problem. It aims to balance class distribution by randomly increasing minority class examples by replicating them. SMOTE synthesizes new minority instances between existing minority instances. In other words, is an oversampling method of balancing class distribution in the dataset It selects the minority examples that are close to the feature space. Then, it draws the line between the examples in the features space and draws a new sample at a point along that line.

LDA: Linear Discriminant Analysis (LDA) is a supervised learning algorithm used for classification tasks in machine learning. It is a technique used to find a linear combination of features that best separates the classes in a dataset.

PCA: Principal component analysis, or PCA, is a statistical procedure that allows you to summarize the information content in large data tables by means of a smaller set of “summary indices” that can be more easily visualized and analyzed.

“Tregs” are regulatory T cells (also called Tregs) are T cells which have a role in regulating or suppressing other cells in the immune system. Tregs control the immune response to self and foreign particles (antigens) and help prevent autoimmune disease. Tregs produced by a normal thymus are termed ‘natural’.

“Cohen Kappa Coefficient” Cohen's kappa coefficient is a statistic that is used to measure inter-rater reliability for qualitative items. It is generally thought to be a more robust measure than simple percent agreement calculation, as κ takes into account the possibility of the agreement occurring by chance.

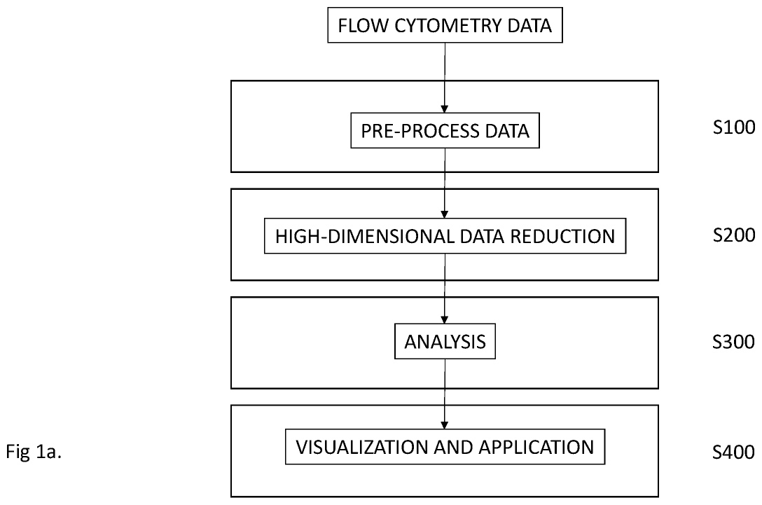

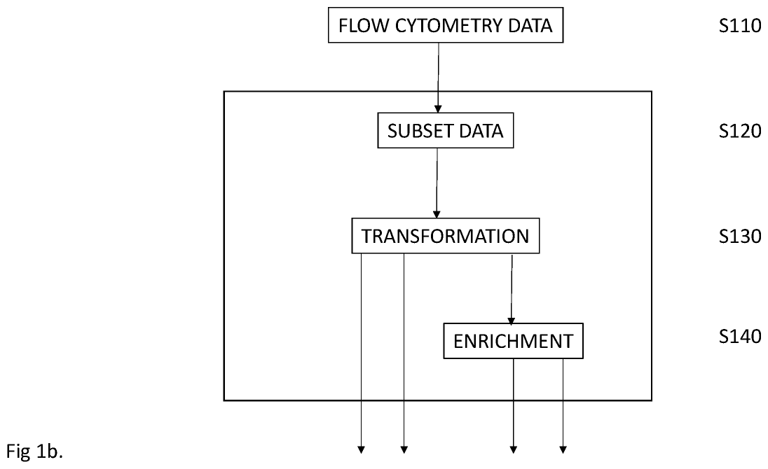

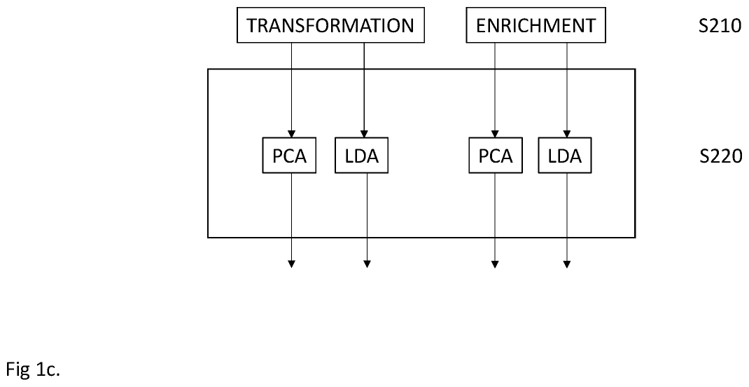

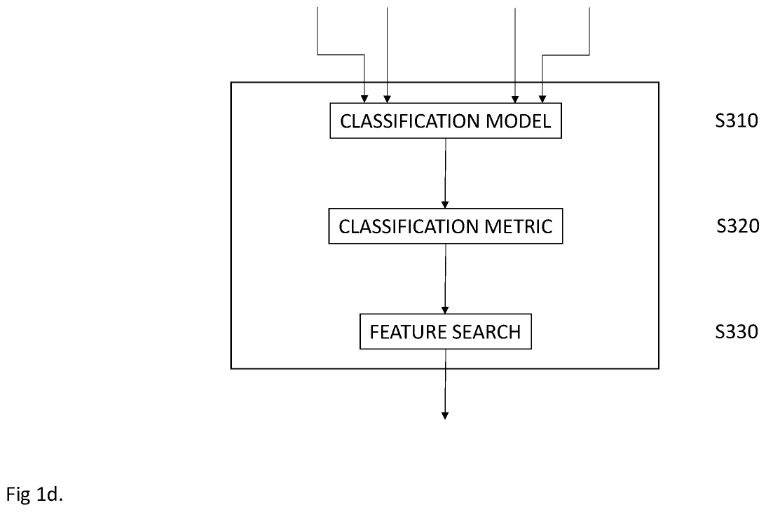

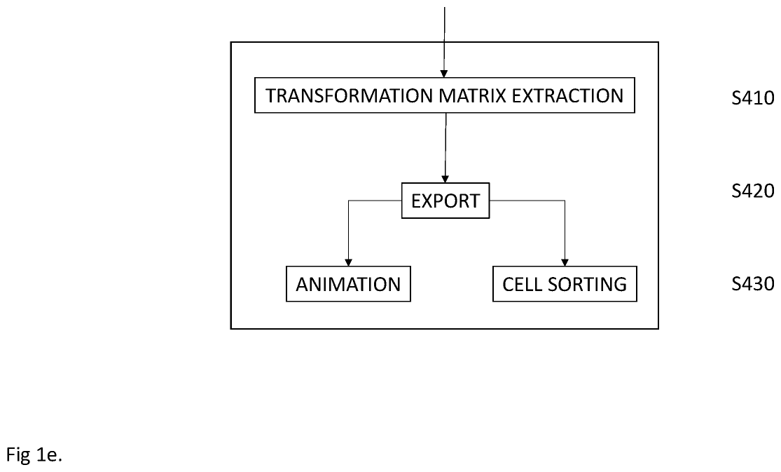

FIG. 1a is a simplified high level illustration of a data analysis process flow, according to one embodiment of the invention. The process flow may include the following steps: obtaining the data; performing dimensional data reduction on the data; analyzing the dimensionally reduced data; and visualizing the analyzed and dimensionally reduced data.

FIG. 1b is an illustration showing further detail of the pre-processing modules. Pre-processing may include at least one of filtering, weighting, extrapolating, interpolating, and smoothing. Its use allows for refinement of the data that is being handled, ultimately leading to more accurate and informative results. If pre-processing were not performed, for example, the subsequent analyses could yield less reliable results. The process begins with subsetting of the data (S120), which ensures the inclusion of only the necessary variables needed for the subsequent processing steps and workflow. The data is then transformed (S140) to optimize the information that can be extracted. The specific transformation is highly dependent on the dataset but in the case of this specific workflow, an h-log transformation is applied. Finally, enrichment (S150) will occur to further enhance the presence of any rare cell population that may be of interest, such as through SMOTE. SMOTE is a commonly used approach that enriches the presence of a minority population that may be present in a dataset. In this case, SMOTE improves balance for the Treg population by augmenting the dataset with synthetic Treg data points. More specifically, SMOTE generates synthetic data points along the Euclidean line connecting two near-by minority data points.

FIG. 1c is an illustration showing further detail of the high dimensional data reduction module. The processed data are channeled through to the high-dimensional data reduction module in four separate pathways (S210), each leading to an independently calculated principal component analysis (PCA) and linear discriminant analysis (LDA) (S220). One dataset undergoes h-log transformation before being applied to the LDA; another is subjected to h-log transformation before PCA application; a third dataset is enriched via SMOTE and then applied to the LDA, and the last one is enriched via SMOTE before undergoing PCA. This separation of pathways facilitates a comprehensive overview of the various high-dimensional data reduction projections. It enables a streamlined process to determine a better-separated target population compared to deploying the high-dimensional data reduction techniques by themselves.

FIG. 1d is an illustration showing further detail of the exhaustive analysis modules. A classification model (S310), e.g. radial basis function support vector machine, can be used to simulate the effectiveness of the proposed combinations of high-dimensional data reduction techniques. The radial basis function is one of the many types of kernel functions, the purpose of which is to define the decision boundary between the data points of interest and all other data points. Kernel functions, such as the radial basis function, are able to compute the decision boundary in higher dimensions while avoiding the complex calculations associated with such a task (known as the “Kernel Trick”). The labels that are fed to the algorithm are extracted from the cells of interest that had been sorted from the instrument prior to this workflow. Following the classification model, a classification metric (S320), e.g. Cohen's kappa coefficient, is applied to quantify the effectiveness of the various combinations of high-dimensional data reduction techniques and their respective projections (PC1, PC2, PC3, LD1, enriched PC1, enriched PC2, enriched PC3, and enriched LD1). All possible combinations are exhaustively searched to finally compute the most effective combination of features (S330), i.e. the combination that yields the best separation for the cell population of interest.

FIG. 1e is an illustration showing further detail of the visualization and application modules. First, extraction of the transformation matrix for the best computed combination of newly created features is done (S410). The transformation matrix is then exported in any file format seen necessary (S420). This file can then be used for any application as seen fit, e.g. visualization or direct implementation onto a flow cytometry instrument (S430). This extracted transformation matrix can be used to directly transform raw fluorescent values on a flow cytometry instrument, allowing the user to effectively gate a target population on a single plot.

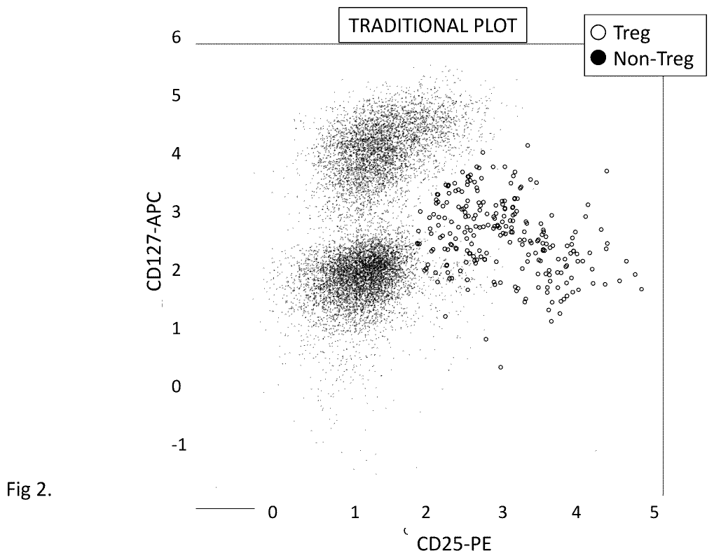

FIG. 2 illustrates the traditional view of how a user would sort or separate the Treg population. Each dot on the plot represents an individual cell following interrogation by the various lasers in the flow cytometry instrument. The x-axis corresponds to the protein, CD25, and its complementary fluorescent marker, PE. A higher value along this axis corresponds to a higher fluorescent signal for this specific protein. The y-axis corresponds to the protein, CD127, and its complementary fluorescent marker, APC. A higher value along this axis corresponds to a higher fluorescent signal for this specific protein. This is the final plot that is usually seen by experts sorting for Treg cells, following a nested gating approach.

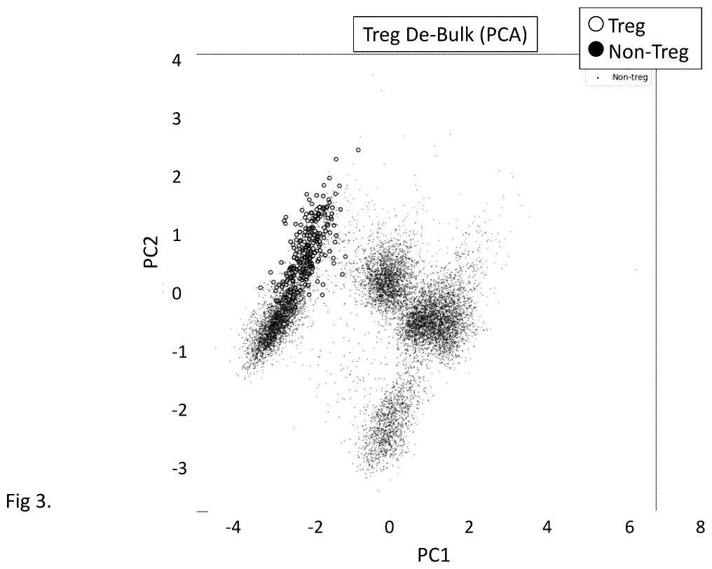

FIG. 3 is an illustration of PCA transformation of the data. The Treg population of interest remains obscured in the main cell population. Each dot on the plot represents an individual cell following interrogation by the various lasers in the flow cytometry instrument, pre-processing (not including SMOTE), and principal component analysis. The x-axis shows principal component 1 while the y-axis shows principal component 2. These principal components are linear combinations of the original features, of which best maximize the variance among the present classes.

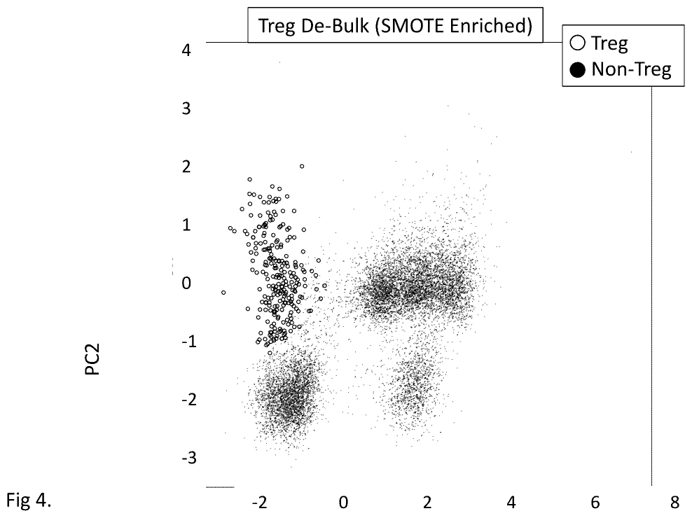

FIG. 4 is an illustration of the transformed dataset following SMOTE enrichment and PCA. Each dot on the plot represents an individual cell following interrogation by the various lasers in the flow cytometry instrument, pre-processing (including SMOTE), and principal component analysis. The Treg population is better resolved than the PCA transformation without SMOTE enrichment. Again, the x-axis shows principal component 1 while the y-axis shows principal component 2. It is clear from this plot that enriching the rare population of Treg cells allows principal component analysis to further improve the separation.

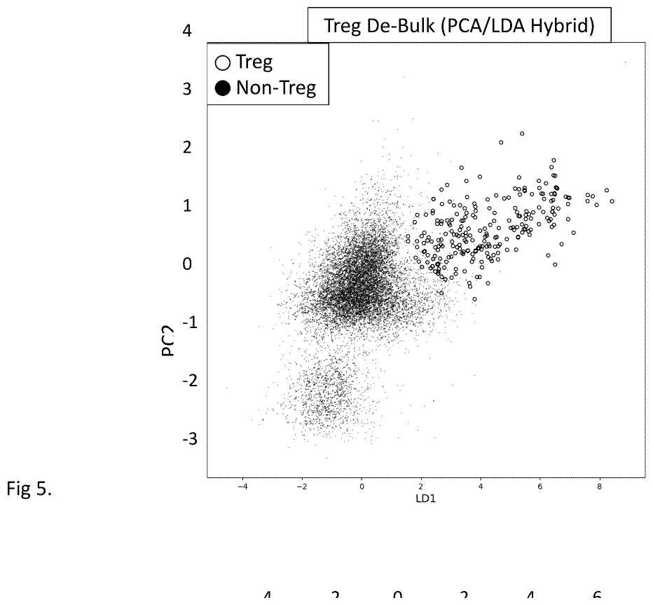

FIG. 5 is an illustration of transformed data following a PCA/LDA hybrid transformation. Each dot on the plot represents an individual cell following interrogation by the various lasers in the flow cytometry instrument, pre-processing (not including SMOTE), principal component analysis, and linear discriminant analysis. Linear discriminant 1 serves as the projection along the x-axis while principal component 2 serves as the projection along the y-axis. This method allows maximizing separation of classes along the x-axis and maximizing variance along the y-axis. This method provides a better separated view of the target population compared to both traditional PCA and traditional gating.

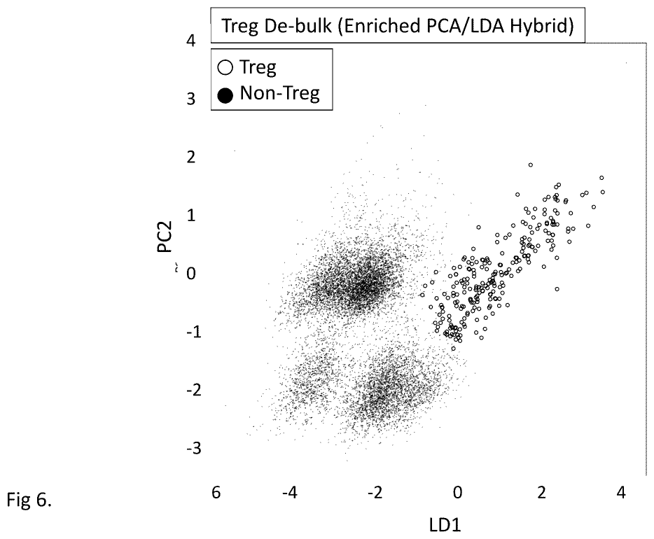

FIG. 6 is an illustration of transformed data following a SMOTE enriched PCA/LDA hybrid transformation. Each dot on the plot represents an individual cell following interrogation by the various lasers in the flow cytometry instrument, pre-processing (including SMOTE), principal component analysis, and linear discriminant analysis. This transformation yields the most resolvable projection for the cell population of interest, Treg's. The x-axis is represented by linear discriminant 1 and the y-axis is represented by principal component 2.

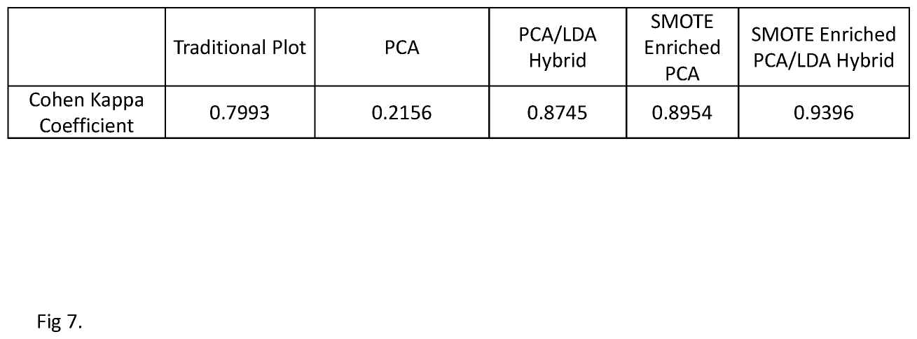

Table 1 below is a table summarizing the data, and is identical to the data shown in FIG. 7.

TABLE 1

| | | | | | SMOTE |
|---|---|---|---|---|---|
| | | | | SMOTE | Enriched |
| | Traditional | | PCA/LDA | Enriched | PCA/LDA |
| | Plot | PCA | Hybrid | PCA | Hybrid |
| Cohen | 0.7993 | 0.2156 | 0.8745 | 0.8954 | 0.9396 |
| Kappa | | | | | |
| Coefficient | | | | | |

The Cohen Kappa Coefficient for each transformation. Larger Cohen Kappa Coefficient corresponds to better sample population separation. The Cohen Kappa Coefficient is the highest for the SMOTE Enriched PCA/LDA Hybrid transformation. Using support vector machines for classification of the Treg cells, we can compare the label found with the support vector machine and the label acquired by the cell sorting instrument to calculate the Cohen Kappa Coefficient.

Table 2 below is a transformation matrix illustrating these concepts.

TABLE 2
Transformation Matrix

| | | | | | | | |
|---|---|---|---|---|---|---|---|
| 0.942160 | −1.107229 | −0.963153 | −0.263663 | 0.302594 | 0.009106 | 1.014261 | 0.106471 |
| −0.173771 | −0.002248 | −0.002170 | −0.930691 | −0.005696 | −0.000298 | 0.321833 | 0.000108 |

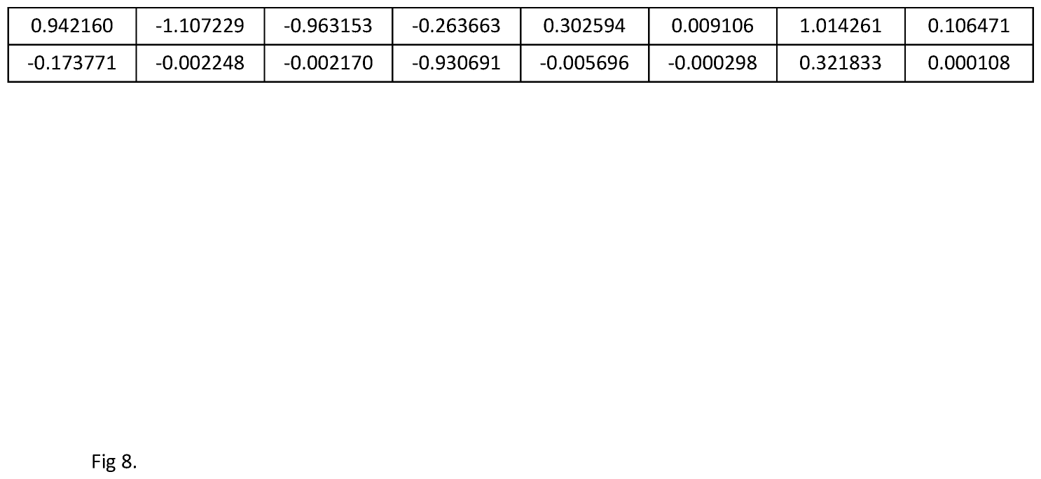

Table 2 is an example transformation matrix, and is identical to FIG. 8. One would need to transpose this matrix and apply a dot product to the raw fluorescent marker values to compute the projected PCA or LDA transformation. By extracting the eigenvector corresponding to linear discriminant 1 in the first row and the eigenvector corresponding to principal component 2 in the second row, we can maximize class separation along the x-axis and maximize variance along the y-axis. Each principal component and linear discriminant will have a representative eigenvector which can be used to project the data. However, only the top three principal components and the single linear discriminant are used for this workflow. Since we are projecting the data along two dimensions, only two eigenvectors are needed for each combination.

In flow cytometry, it may be important to reject measurements when more than one cell crosses the laser at the same time. This is commonly referred to as coincidence detection or doublet detection. The most common way to deal with coincidence is called a singlet gate. This requires users to create a 2-dimensional plot using a combination of height, area, and width, and drawing a gate around the single-cell pulses. The details of this approach include which plot to use and what the gate needs to look like. These details can be different on different instruments, and is also subject to user biases and habits.

Another way to detect coincidence is to measure the symmetry of the pulses. Because there are many factors that can influence the range and distribution of the pulse symmetry values, it is not simple or straightforward to reliably and accurately detect coincidence using pulse symmetry. The solution being proposed here is to dynamically calculate the median and distribution of the symmetry values. Once this information is known, it is possible to reject a specific % of the pulses that are furthest from the median of the distribution. Poisson distribution statistics are used to determine what percentages of pulses should be overlapping. This information is used to set the percentage of the pulses that will be rejected as coincident. All of these calculations must be performed on the most recent data in order to handle drifts over time.

While various details have been described in conjunction with the exemplary implementations outlined above, various alternatives, modifications, variations, improvements, and/or substantial equivalents, whether known or that are or may be presently unforeseen, may become apparent upon reviewing the foregoing disclosure. Accordingly, the exemplary implementations set forth above, are intended to be illustrative, not limiting.

What is claimed is:

1. A method for analyzing data output of a particle manipulation device, comprising:
obtaining the data;
performing dimensional data reduction on the data;
analyzing the dimensionally reduced data; and
visualizing the analyzed and dimensionally reduced data.

2. The method of claim 1, further including pre-processing the data, wherein preprocessing further includes at least one of filtering, gating, truncating, smoothing, interpolating, extrapolating and/or weighing of data.

3. The method of claim 1, wherein the enrichment of the data further includes applying SMOTE techniques.

4. The method of claim 1, wherein dimensional data reduction further includes at least one of LDA and PCA.

5. The method of claim 1, wherein the analyzing further includes at least one of applying a classification metric and a classification model to the dimensionally reduced data.
